(19) United States
(12) Patent Application Publication
(10) Pub. No.: US 2026/0094777 A1
(43) Pub. Date: Apr. 2, 2026

(54) Switching Assembly with Auxiliary Body for Switching Point Adjustment

(71) Applicant: Robert Bosch GmbH, Stuttgart (DE)

(72) Inventors: Igor Glaz, Ulm (DE); Benjamin Weihing, Haiterbach (DE)

(21) Appl. No.: 19/341,453

(22) Filed: Sep. 26, 2025

(30) Foreign Application Priority Data
Sep. 27, 2024 (DE) 10 2024 209 379.3

(51) Int. Cl. H01H 13/06; H01H 9/04; H01H 13/10; H01H 13/14

(52) U.S. Cl. CPC H01H 13/06; H01H 13/10; H01H 13/14; H01H 2009/048

(57) ABSTRACT

A switching assembly including a base body in which a plunger is accommodated so as to be linearly movable in the direction of a longitudinal axis. A switching device is provided which is actuatable by way of the plunger. The switching device has a first external thread which is arranged concentrically to the longitudinal axis and which is screwed into a first internal thread, wherein a separate lock nut is provided. A separate auxiliary body is provided, wherein the first internal thread is arranged on the auxiliary body. The first external thread is screwed into the first internal thread in such a way that the switching device is braceable to the auxiliary body. The auxiliary body has a second and a third external thread which are each arranged concentrically to the longitudinal axis. The second external thread is screwed into a second internal thread on the base body. The lock nut is screwed onto the third external thread, wherein it is braceable against the base body. The auxiliary body is sealed against the base body.

This application claims priority under 35 U.S.C. § 119 to application no. DE 10 2024 209 379.3, filed on Sep. 27, 2024 in Germany, the disclosure of which is incorporated herein by reference in its entirety.

The disclosure relates to a switching assembly according to the description set forth below.

### BACKGROUND

DE 10 2018 201 937 A1 discloses a switching assembly whose switching device is actuated by a plunger that is movable along a longitudinal axis. The switching assembly has a first external thread, which is screwed into a first internal thread on a base body of the switching assembly. This screw connection is used to set the switching point of the switching assembly, wherein the setting is secured by way of a lock nut. It is possible that liquid may enter the interior of the switching assembly from the environment via the two screw connections, namely via the screw connection between the lock nut and the first base body, and the screw connection between the first external thread and the first internal thread. Although the penetrating moisture should be sealed by an O-ring stack, it has been shown that moisture may still penetrate through the O-ring stack to the switching device, causing it to fail due to the penetrating moisture. This problem mainly occurs if the O-ring stack is incorrectly fitted, and correct fitting is difficult to monitor.

The object of the disclosure is to improve the sealing of the switching assembly against liquid penetrating from the outside.

### SUMMARY

Accordingly, it is proposed that a separate auxiliary body is provided, wherein the first internal thread is arranged on the auxiliary body, wherein the first external thread is screwed into the first internal thread such that the switching device is braceable to the auxiliary body, wherein the auxiliary body has a second and a third external thread, which are each arranged concentrically to the longitudinal axis, wherein the second external thread is screwed into a second internal thread on the base body, wherein the lock nut is screwed onto the third external thread, wherein it is braceable against the base body, wherein the auxiliary body is sealed against the base body.

This means that the screw connection between the first external thread and the first internal thread is no longer moved after initial installation. This screw connection may thus be sealed without difficulty. It is contemplated that hemp or a PTFE tape may be used for this purpose, wherein the first sealing ring explained below is preferred. The sealing of the screw connection on the lock nut, namely on the third external thread, is no longer important. In fact, the large auxiliary body may be easily sealed against the base body. Preferably, the second sealing ring described below is used for this purpose. Instead, however, a gap seal is also conceivable by adapting the auxiliary body to the base body with high precision, wherein the corresponding sealing surfaces are preferably circular-cylindrical in relation to the longitudinal axis.

Preferably, the switching device is braced against the auxiliary body, most preferably directly braced, in particular, without an additional lock nut. Preferably, the lock nut is braced against the base body.

Advantageous further developments and improvements of the disclosure are specified below.

A first sealing ring may be provided, which surrounds the longitudinal axis, wherein it is installed in the area of an outlet opening of the first internal thread between the auxiliary body and the switching device. The corresponding seal may be made completely tight without any problems. Preferably, the first sealing ring is configured as an O-ring.

It may be provided that the first sealing ring is installed in the direction of the longitudinal axis between the auxiliary body and the switching device in such a way that it is compressible by screwing the first external thread into the first internal thread. The corresponding preload of the first sealing ring improves the seal. Preferably, the first sealing ring is compressible by screwing the first external thread into the first internal thread. Preferably, the desired preload is achieved when the switching device is in direct contact with the auxiliary body away from the first sealing ring.

A second sealing ring may be provided, which surrounds the longitudinal axis, wherein it is arranged in the direction of the longitudinal axis between the second and the third external thread. The second sealing ring is preferably in sealing contact with the base body and the auxiliary body. This may create a seal that remains tight even after the switching point has been adjusted.

It may be provided that the second sealing ring is arranged radially to the longitudinal axis between the auxiliary body and the base body. This means that the adjustment of the switching point by the second sealing ring is essentially not hindered.

It may be provided that the auxiliary body has a first sealing surface which is circularly cylindrical with respect to the longitudinal axis, wherein the first sealing surface is arranged in the direction of the longitudinal axis between the second and the third external thread, wherein the base body has a second sealing surface which is circularly cylindrical with respect to the longitudinal axis and which surrounds the first sealing surface, wherein the second sealing ring is installed between the first and the second sealing surface, wherein it contacts the first and the second sealing surface in a sealing manner. As a result, the adjustment of the switching point by the second sealing ring is almost completely unhindered.

It may be provided that a diameter of the first sealing surface and a diameter of the second sealing surface and the second sealing ring are matched to each other in such a way that the second sealing ring is installed under preload between the first and the second sealing surface. The aforementioned preload improves the sealing effect of the second sealing ring.

It may be provided that a diameter of the first sealing surface is smaller than a core diameter of the second external thread and smaller than a core diameter of the third external thread. This simplifies the production of the second and third external threads, as the area of the first sealing surface acts like an undercut at the end of the external threads mentioned. The final machining of the first sealing surface, for example, by turning, may take place before the two external threads mentioned are produced without damaging the first sealing surface.

It may be provided that the outer diameter of the third external thread is between 90% and 110% of the outer diameter of the second external thread. Preferably, the outer diameter of the second external thread and the outer diameter of the third external thread are the same. This means that the switching assembly requires very little installation space.

It may be provided that the auxiliary body has an opening through it in the direction of the longitudinal axis, wherein the plunger passes through the opening in such a way that it may actuate the switching device. The opening may be provided with a hexagon socket, wherein the auxiliary body may be braced with the switching device using the hexagon socket, preferably braced.

It may be provided that the second external thread and the associated second internal thread are configured as fine pitch threads. This allows the switching point of the switching device to be set particularly precisely. Fine pitch threads, for example, are the subject of the DIN 13-2 standard. Preferably, the first and/or the third external thread are configured as a standard thread. Standard threads, for example, are the subject of the ISO 261 standard.

It is possible that the pitch direction of the first external thread and the pitch direction of the third external thread are selected in opposite directions. This prevents the switching device from being released when the lock nut is tightened. Preferably, the third external thread is configured as a left-hand thread, wherein the first external thread is preferably configured as a right-hand thread.

Of course, the above-mentioned features and those to be explained below may be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The FIGURE shows:

FIG. 1 a longitudinal section of a switching assembly according to the disclosure, which is mounted on a higher-level assembly.

### DETAILED DESCRIPTION

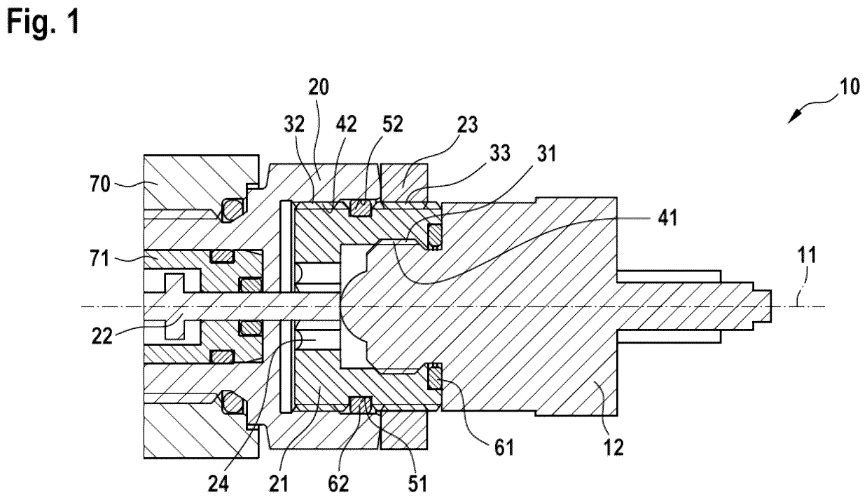

FIG. 1 shows a longitudinal section of a switching assembly 10 according to the disclosure, which is mounted on a higher-level assembly 70. The sectional plane coincides with the longitudinal axis 11. The higher-level assembly 70 may be an axial piston machine or another hydraulic machine. The switching device 12 comprises, for example, an electrical switch which is actuated when the displacement volume zero of said axial piston machine is set. The corresponding adjustment movement, for example, the movement of a swashplate-type axial piston machine, is transmitted to the switching device 12 by way of the plunger 22, which moves in the direction of the longitudinal axis 11. The switching device 12 may be a mechanical switch, although contactless switches, such as proximity switches, are also useable.

In order for the switching point to be adjustable, the position of the switching device 12 along the longitudinal axis 11 is adjustable via the threaded engagement between the second external thread 32 and the second internal thread 42 in the direction of the longitudinal axis 11. The corresponding setting is secured by way of a lock nut 23. Preferably, the second external thread 32 is configured as a fine pitch thread in order to enable precise adjustment of the switching point of the switching device 12. The third external thread 33 is preferably configured as a left-hand thread, wherein the first external thread 31 is configured as a right-hand thread. This prevents the switching device 12 from loosening when the lock nut 23 is tightened.

The second internal thread 42 is arranged on a base body 20 of the switching assembly 10, wherein the base body 20 is fastened, for example, screwed, to the higher-level assembly 70. The second external thread 32 is arranged on a separate auxiliary body 21. The switching device 12 is screwed to the auxiliary body 21, wherein the switching device 12 has a first external thread 31, which is screwed into a first internal thread 41 of the auxiliary body 21. The lock nut 23 is screwed onto a third external thread 33 of the auxiliary body 21, wherein it is braced against the base body 20.

The auxiliary body 21 is penetrated in the direction of the longitudinal axis 11 by an opening 24, which opens into the first internal thread 41. The plunger 22 passes through the opening 24, such that it may actuate the switching device 12. The opening 24 is provided with a hexagon socket, such that a hexagon socket wrench may be applied there to tighten the auxiliary body 21 against the switching device 12.

On the one hand, the switching assembly 10 is sealed against the ingress of liquids from the outside. At the same time, the seal is configured in such a way that liquids from the interior of the higher-level assembly 70 may not escape to the environment via the switching assembly 10. It should be noted here that the interior of an axial piston machine is filled with hydraulic fluid, which is often under a pressure that is slightly higher than the ambient air pressure.

There is no movement between the auxiliary body 21 and the switching assembly 10 after initial assembly. The first sealing ring 61 there, which is preferably configured as an O-ring, surrounds the longitudinal axis 11. It is arranged in the area of the outlet opening of the first internal thread 41, wherein it is installed between the auxiliary body 21 and the switching device 12 in the direction of the longitudinal axis 11 under preload. The aforementioned preload is brought about by screwing the first external thread 31 into the first internal thread 41. The desired preload is achieved when the switching device 12 is in direct contact with the auxiliary body 21 away from the first sealing ring 61.

A second sealing ring 62 is arranged between the base body 20 and the auxiliary body 21. Since this sealing action involves movement to set the switching point, the sealing concept of the first sealing ring 61 may not be adopted here. The second sealing ring 62 surrounds the longitudinal axis 11, preferably in the form of an O-ring. Radially on the inside, it lies against a first sealing surface 51 on the auxiliary body 21, which is circular-cylindrical in relation to the longitudinal axis 11. Radially on the outside, the second sealing ring 62 is in contact with a second sealing surface 52 on the base body 20, which is circular-cylindrical in relation to the longitudinal axis 11.

The first sealing surface 51 is arranged in the direction of the longitudinal axis 11 between the second and third external threads 32; 33. Its diameter is smaller than a core diameter of the second external thread 32 and smaller than a core diameter of the third external thread 33. Preferably, the outer diameter of the second external thread 32 is the same as the outer diameter of the third external thread 33.

It should also be noted that there is a separate guide insert 71, which serves to guide the plunger 22 in the direction of the longitudinal axis 11. The guide insert 71 is installed stationary in the base body 20, such that the plunger is at least indirectly guided on the base body 20.

### REFERENCE SIGNS

10 switching assembly
11 longitudinal axis
12 switching device
20 base body
21 auxiliary body
22 plunger
23 lock nut
24 opening
31 first external thread
32 second external thread
33 third external thread
41 first internal thread
42 second internal thread
51 first sealing surface
52 second sealing surface
61 first scaling ring
61 second scaling ring
70 higher-level assembly
71 guide insert

What is claimed is:

1. A switching assembly, comprising:
a base body in which a plunger is accommodated so as to be linearly movable in the direction of a longitudinal axis;
an auxiliary body having a first internal thread arranged thereon;
a switching device which is actuatable by way of the plunger, wherein the switching device has a first external thread which is arranged concentrically to the longitudinal axis and which is screwed into the first internal thread; and
a lock nut;
wherein the first external thread is screwed into the first internal thread in such a way that the switching device is braced against to the auxiliary body,
wherein the auxiliary body has a second external thread and a third external thread which are each arranged concentrically to the longitudinal axis,
wherein the second external thread is screwed into a second internal thread on the base body,
wherein the lock nut is screwed onto the third external thread so as to be braced against the base body, and
wherein the auxiliary body is sealed against the base body.

2. The switching assembly according to claim 1, further comprising a first sealing ring which surrounds the longitudinal axis, wherein the sealing ring is installed between the auxiliary body and the switching device in the region of an outlet opening of the first internal thread.

3. The switching assembly according to claim 2, wherein the first sealing ring is installed in the direction of the longitudinal axis between the auxiliary body and the switching device in such a way that the first sealing ring is compressible by screwing the first external thread into the first internal thread.

4. The switching assembly according to claim 1, further comprising a second sealing ring which surrounds the longitudinal axis, wherein the second sealing ring is arranged in the direction of the longitudinal axis between the second external thread and the third external thread.

5. The switching assembly according to claim 4, wherein the second sealing ring is arranged radially to the longitudinal axis between the auxiliary body and the base body.

6. The switching assembly according to claim 4, wherein:
the auxiliary body has a first sealing surface which is circular-cylindrical with respect to the longitudinal axis,
the first sealing surface is arranged in the direction of the longitudinal axis between the second external thread and the third external thread,
the base body has a second sealing surface which is circular-cylindrical with respect to the longitudinal axis and which surrounds the first sealing surface,
the second sealing ring is installed between the first sealing surface and the second sealing surface, and
wherein the second sealing ring contacts the first sealing surface and the second sealing surface in a sealing manner.

7. The switching assembly according to claim 6, wherein a diameter of the first sealing surface and a diameter of the second sealing surface and the second sealing ring are matched to one another such that the second sealing ring is installed under preload between the first sealing surface and second sealing surface.

8. The switching assembly according to claim 6, wherein a diameter of the first sealing surface is smaller than a core diameter of the second external thread and smaller than a core diameter of the third external thread.

9. The switching assembly according to claim 1, wherein an outer diameter of the third external thread is between 90% and 110% of the outer diameter of the second external thread.

10. The switching assembly according to claim 1, wherein:
the auxiliary body has an opening passing therethough in the direction of the longitudinal axis, and
the plunger passes through the opening in such a way that the plunger actuates the switching device.

11. The switching assembly according to claim 1, wherein the second external thread and the second internal thread are configured as fine pitch threads.

12. The switching assembly according to claim 1, wherein the pitch direction of the first external thread and the pitch direction of the third external thread are selected in opposite directions.
